(19) United States
(12) Patent Application Publication
(10) Pub. No.: US 2005/0155001 A1
(43) Pub. Date: Jul. 14, 2005

(54) Method for designing a semiconductor integrated circuit and a semiconductor integrated circuit

(75) Inventors: Koichi Kinoshita, Yokohama-shi (JP); Takeshi Ishigaki, Edogawa-ku (JP); Yukihiro Urakawa, Kawasaki-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 10/988,658

(22) Filed: Nov. 16, 2004

(30) Foreign Application Priority Data
Nov. 18, 2003 (JP) 2003-388357

(51) Int. Cl. G06F 17/50

(52) U.S. Cl. 716/2; 716/6; 716/10; 716/13

(57) ABSTRACT

A method for designing a semiconductor integrated circuit, includes placing first, second and third cells, respectively including first stage synchronous circuit having signal propagation time, second stage synchronous circuit having a signal propagation time almost equal to the first stage synchronous circuit, and logic circuit; routing wirings so as to electrically connect the first to third cells; verifying signal propagation timing of the semiconductor integrated circuit having the first to third cells; adjusting the signal propagation timing based on critical path of the signal propagation timing of the semiconductor integrated circuit; and extracting the critical path to replace the second stage synchronous circuit by synchronous circuit of different synchronous type from the first stage synchronous circuit so as to provide a shorter signal propagation time than the first stage synchronous circuit.

### CROSS REFERENCE TO RELATED APPLICATIONS

This application is based upon and claims the benefit of priority from prior Japanese Patent Application P2003-388357 filed on Nov. 18, 2003; the entire contents of which are incorporated by reference herein.

### BACKGROUND OF THE INVENTION

1. Field of the Invention

The present invention relates to a method for designing a semiconductor integrated circuit by use of a computer system, and a semiconductor integrated circuit.

2. Description of the Related Art

According to a current method for designing a semiconductor integrated circuit, for example, a floor planning step is first executed to decide a layout of cells in conformity with a logic design specification, and then a logic synthesis step is executed in conformity with an executed floor planning.

Subsequently, after an automated placement and routing step of automatically deciding electrical routing between cells or between cells and bonding pads, a timing verification step is executed on a computer for the semiconductor integrated circuit which has been subjected to logic synthesis, and a timing adjustment step is manually executed between logic circuits in the semiconductor integrated circuit.

Lastly, after another automated placement and routing step is executed to fine-tune the placements of the cells or routed wirings between the cells, another timing verification step is executed to determine whether the semiconductor integrated circuit satisfies timing characteristics or not.

Moreover, in a design method of a semiconductor integrated circuit by use of a critical path, a plurality of flip-flop (FF) circuits having a different set-up time are first prepared. A spare time is calculated for each critical path between FF circuits and subsequent stage FF circuits. Then, a set-up time is calculated for a subsequent stage FF circuit in a critical path where the spare time is shortest.

The subsequent stage FF circuit is replaced by a FF circuit having a shorter set-up time than the calculated set-up time. Thus, a spare time for a critical path is increased without increasing a layout area of the semiconductor integrated circuit (refer to Japanese Patent Laid-Open No. Hei10(1998)-313057).

Currently, in order to correct a critical path detected in the timing adjustment step, the floor planning step or reviewing of restrictions in designing placement and routing is executed. Alternatively, the timing verification step is executed again.

### SUMMARY OF THE INVENTION

A first aspect of the present invention inheres in a computer implemented method for designing a semiconductor integrated circuit including placing a first cell including a first stage synchronous circuit having a signal propagation time, a second cell including a second stage synchronous circuit having a signal propagation time almost equal to the first stage synchronous circuit, and a third cell including a logic circuit to be placed between the first stage synchronous circuit and the second stage synchronous circuit; routing wirings so as to electrically connect the first to third cells; verifying a signal propagation timing of the semiconductor integrated circuit having the first to third cells; adjusting the signal propagation timing based on a critical path of the signal propagation timing of the semiconductor integrated circuit; and extracting the critical path placed between the first and second synchronous circuit to replace the second stage synchronous circuit by a synchronous circuit of a different synchronous type from the first stage synchronous circuit so as to provide a shorter signal propagation time than the first stage synchronous circuit.

A second aspect of the present invention inheres in a semiconductor integrated circuit including a flip-flop mixed region including a master-slave flip-flop and a pulse-triggered flip-flop, the master-slave flip-flop and the pulse-triggered flip-flop having substantially the same area, the pulse-triggered flip-flop being placed in a vicinity of the master-slave flip-flop; and a clock generator configured to supply a clock signal to the master-slave flip-flop.

### BRIEF DESCRIPTION OF THE DRAWINGS

FIG. 1 is a flowchart showing an example of a method for designing a semiconductor integrated circuit according to an embodiment of the present invention;

FIGS. 2A and 2B are examples of timing charts of a synchronous circuit and a pulse generator used for the embodiment of the present invention;

FIGS. 3A and 3B are examples of timing charts of a synchronous circuit and a delay circuit used for a first example of the embodiment of the present invention;

FIGS. 4A and 4B are examples of a timing chart of a synchronous circuit and a pulse generator used for a second example of the embodiment of the present invention;

FIG. 5 is a circuit diagram of an example of the synchronous circuit used for the embodiment of the present invention;

FIG. 6 is a circuit diagram of other example of the synchronous circuit used for the embodiment of the present invention;

FIGS. 7A to 7D are examples of synchronous circuits and timing charts of the synchronous circuits used for a third example of the embodiment of the present invention;

FIG. 8 is an example of a timing chart of a synchronous circuit used for a fourth example of the embodiment of the present invention;

FIGS. 9A and 9B are examples of a synchronous circuit and timing charts of synchronous circuits used for a fifth example of the embodiment of the present invention;

FIGS. 10A and 10B are block diagrams of examples of synchronous circuits used for a sixth example of the embodiment of the present invention; and

FIG. 11 is a schematic plan view of a standard cell used for a seventh example of the embodiment of the present invention.

### DETAILED DESCRIPTION OF THE INVENTION

Various embodiments of the present invention will be described with reference to the accompanying drawings. It is to be noted that the same or similar reference numerals are applied to the same or similar configuration throughout the drawings, and the description of the same or similar configuration will be omitted or simplified.

In a method for designing a semiconductor integrated circuit of an embodiment of the present invention, for example, signal propagation timings are verified in a semiconductor integrated circuit having a plurality of cells in which a first stage synchronous circuit and a second stage synchronous circuit each having predetermined signal propagation time, and a logic circuit placed between the first and second stage synchronous circuits are electrically connected. The signal propagation timing is adjusted, for example, by increasing or decreasing clock frequency or phase difference, based on a critical path of the signal propagation timing obtained as a result of the timing verification. When the critical path is extracted, the second stage synchronous circuit is replaced with a synchronous circuit having a signal propagation time shorter than the first stage synchronous circuit. Thus, it is possible to design a semiconductor integrated circuit of a high-speed operation within a short duration without executed again floor planning including the placement and routing of a delay circuit.

Additionally, in the semiconductor integrated circuit, the second stage synchronous circuit providing the critical path due to the signal propagation time of the second stage synchronous circuit is identified in order to replace with a synchronous circuit having a signal propagating time shorter than the predetermined signal propagating time. Thus, it is possible to suppress increases in power consumption and in chip area while a high-speed operation is maintained.

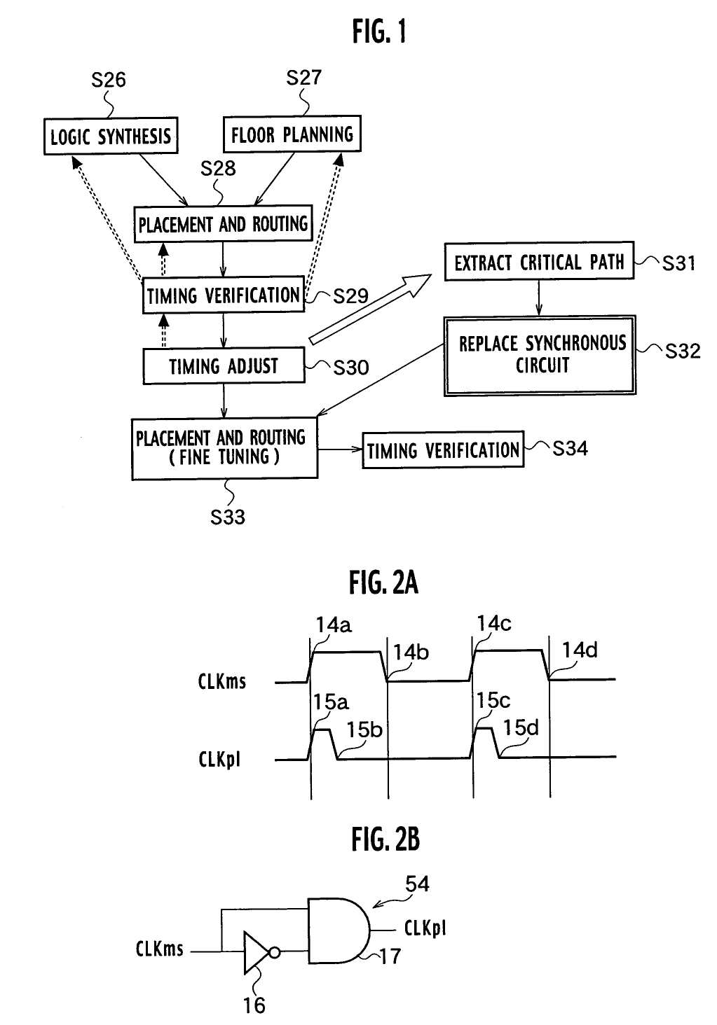

A method for designing a semiconductor integrated circuit according to the embodiment of the present invention will be described with reference to a flowchart of FIG. 1. A computer is used to executed the method, in which a memory unit is installed to store a logic design specification, a circuitry database, a restriction specification, and the like.

The circuitry database saves a variety of logic circuits to build the plurality of cells by use of a metal-oxide-semiconductor (MOS) transistor or a complementary MOS (CMOS) transistor, and the like. In the plurality of cells, a FF circuit or a latch circuit of a master-slave type (hereinafter refer to a master-slave FF circuit), or of a pulse-triggered type (hereinafter refer to a pulse-triggered FF circuit), as a synchronous circuit, a multiplexer, a demultiplexer, and the like, can be applied. The logic circuits include sequential circuits such as an AND gate, an OR circuit, an exclusive OR circuit and the like, which perform logical functions, delay circuits which adjust signal propagating timing, and the like.

The designing by use of the cells enables a great reduction in labor and time for circuit designing, compared with designing of a large scale integrated circuit (LSI) of custom specifications. A standard cell system in which any standard cells are selected and combined can provide a semiconductor integrated circuit of a high-speed operation and high stability within a short time.

The restriction specification defines a plurality of restrictions for placement of the plurality of cells and routing of wirings, such as conditions on the width of a wiring for electrically interconnecting the cells, a space between wirings (or sometimes referred to as an interline space), and a length of a wiring (e.g., distance from a contact region of a first stage circuit to a contact region of a second stage circuit). Additionally, the restrictions include a condition on maximum power consumption of all the logic-synthesized cells. Furthermore, the restrictions are defined to automatically place a buffer circuit between cells when the length of a wiring exceeds a predetermined length.

In step S26, a logic synthesis is executed in conformity with the logic design specification and the circuitry database so as to generate a plurality of cells having a variety of logic circuits for a semiconductor integrated circuit. In step S27, using the plurality of cells, a floor planning process which may have a high possibility to involve a significant change on designing the semiconductor integrated circuit, is executed. In step S28, based on a result of the floor planning, the restrictions stored in the restriction specification for the cell placement and wiring routing are determined to review. Such prior close examination on the restrictions provides an advantage of achieving a higher speed and lower power consumption of the semiconductor integrated circuit.

Further in step S28, by automated placement and routing, the plurality of cells are placed in positions of a layout decided by the floor planning so as to determine a wiring layout for electrically interconnecting the cells. Thus, primary design data of the semiconductor integrated circuit is generated.

The primary design data is stored in the memory unit of the computer. For all the FF circuits as synchronous circuits in the primary design data, signal propagation time is standardized to a predetermined time period. Therefore, the circuit designing can be simplified.

For example, it is possible to use a master-slave FF circuit that synchronizes with a clock signal in which the duty ratio of logic “1” to logic “0” is 1:1. The master-slave FF circuit operates at the maximum target operation frequency, and balance of power consumption to a cell area is previously verified.

Thus, even if the sum of cell areas of the FF circuits reaches a several-ten percent of the entire semiconductor integrated circuit, it is possible to satisfy specifications of the cell areas and power consumption as not to be restricted by the maximum rating of power consumption of the entire chip.

Subsequently, in step S29, the primary design data is read from the memory unit in order to verify on the computer whether all the logic circuits and all the synchronous circuits operate at a predetermined frequency. For example, a clock signal for verification which is not lower than one GHz is transmitted to the synchronous circuit such as the FF circuit or the latch circuit. Thus, by verification function, it is possible to verify whether or not a data signal is correctly transferred through the synchronous circuit.

Additionally, all paths placed between the first and second stage synchronous circuits are verified to determine a critical path. Incidentally, when a verification result of a nonconforming value is read out from the timing verification in step S29, which is very rare, due to a bug or the like in the design data of the semiconductor integrated circuit, the process returns again to the floor planning in step S27, as indicated by the broken arrow in FIG. 1, to reassign placement of the cells.

If a verification result of a conforming value is obtained from the timing verification in step S29, the process moves to a timing adjustment. The semiconductor integrated circuit built by the verified primary design data satisfies a target electric specification stored in the memory unit as a standard specification. However, it is difficult to guarantee a high-speed operation of a circuit in which a critical path has been determined.

In step S30, by timing adjustment processing, for example, a master clock signal and a delay clock signal which have phases different from each other are generated. The master clock signal and the delay clock signal are respectively transmitted to the first and second stage synchronous circuits to adjust the high-speed operation of the circuit by verification function.

In this case, to determine a permissible level of a phase difference (e.g., phase angle of 0° to 90°) between the master clock signal and the delay clock signal, a high-speed operation of the critical path is detected by adjusting the phase difference. Information of the detected critical path can be stored as cell data added on the primary design data in the memory unit.

In addition, the timing adjustment in step S30 is executed not for all the paths between the cells but for the circuit in which the critical path has been determined in the timing verification in step S29. Therefore, designing efficiency can be improved to decrease a designing time period, for example, running time of the computer.

Here, “critical path” used in the embodiment of the present invention means a path in which a “punch through” phenomenon of a data signal easily occurs between synchronous circuits controlled by the clock signal. A “punch through” means that a data signal fed from a preceding stage cannot hold in a synchronous circuit to pass through to a subsequent stage. For example, the critical path may be a shift register which has no sequential circuit performing logical functions between the first and second stage synchronous circuits. Additionally, the critical path may be a delay circuit for changing set-up time between the first and second stage synchronous circuits, in which a signal propagation time is too short, or a circuit in which a number of delay circuits is not enough to secure a set-up time for the second stage synchronous circuit.

In a method for designing a semiconductor integrated circuit according to the embodiment of the present invention, the set-up time of the circuit having a critical path is improved on the computer. As a result, all the synchronous circuits synchronized with the clock signal may accurately transfer data from the first stage synchronous circuit to the second stage synchronous circuit. Thus, it is possible to achieve a high-speed operation and high reliability for the entire semiconductor integrated circuit.

Furthermore, in the timing adjustment in step S30, for example, the clock frequency for verification used in the timing verification in step S29 may be increased to detect a critical path. Information of the detected critical path can be stored as cell data added on the primary design data in the memory unit. In this case, the timing adjustment in step S30 is executed not for all the paths between the cells but for the circuit in which the critical path has been determined in the timing verification in step S29. Therefore, designing efficiency can be improved to decrease a designing time period, for example, running time of the computer.

In the embodiment of the present invention, the floor planning having a high possibility to involve a significant change on designing the semiconductor integrated circuit, and reviewing of restrictions in the automated placement and routing are determined at an initial stage of designing the semiconductor integrated circuit. Thereafter, an operation guarantee of the critical path is detected or determined in the timing adjustment processing. Therefore, significant rework on designing the semiconductor integrated circuit can be prevented.

Additionally, when no critical path is detected in the semiconductor integrated circuit in the timing adjustment, a designing flow moves to fine tuning of placement and routing in step S33, and it is determined that fine-tuning of placement and routing of the cell is not necessary. The design of the semiconductor integrated circuit is completed with the primary design data. Thus, the design of the semiconductor integrated circuit can be provided with the minimum time period.

On the basis of the primary design data of the semiconductor integrated circuit, for example, reticle (or photomask) design data used for photolithography, and control data for an electron beam (EB) exposure tool can be generated. Furthermore, on the basis of the reticle design data or the control data for an EB exposure tool, data for a wafer probe test or data for shipping inspection of completed semiconductor devices can be generated.

On the other hand, when a critical path is detected in the semiconductor integrated circuit in the timing adjustment, in step S31, the critical path detected by the timing adjustment is read out and extracted from the memory unit, by critical path extraction.

In step S32, a buffer circuit can be inserted into a data input terminal of a synchronous circuit cell connected to a subsequent stage of the critical path. A size of the buffer circuit may be reviewed. Alternatively, a transistor as a switching means which is provided in the synchronous circuit connected to the subsequent stage of the critical path can be replaced by a low-threshold transistor with a potential lower than a threshold of a transistor-transistor logic (TTL) level or a threshold of a CMOS level. Additionally, in step S32, replacement of a master-slave FF circuit as the synchronous circuit which is connected to the subsequent stage of the critical path, can be executed to replace the master-slave FF circuit to a pulse-triggered FF, for example. Furthermore, the pulse-triggered FF circuit replacing a FF circuit which is not pulse-triggered type such as a master-slave FF circuit, may be processed by the above-mentioned procedure similar to the replacement to the low-threshold transistor.

Thus, the replacement of the synchronous circuit can be executed between a plurality of options. The above-described steps of inserting the buffer circuit in the synchronous circuit cell connected to the subsequent stage of the critical path and replacing the synchronous circuit may be repeated in any order. A secondary design data for the semiconductor integrated circuit after the synchronous circuit replacement for replacing the synchronous circuit connected to the subsequent stage of the critical path is stored in the memory unit.

Next, the process moves to fine-tuning of placement and routing in step S33. When fine-tuning of placement of cells and routing of wirings is necessary, a cell layout and routing are properly fine-tuned. Thereafter, a tertiary design data for the semiconductor integrated circuit in which the cell layout and the routing have been changed, is stored in the memory unit.

Subsequently, in step S34, the secondary or tertiary design data is read from the memory unit, timing verification of the semiconductor integrated circuit is executed, and verification is executed so as to determine whether or not all the synchronous circuits in the semiconductor integrated circuit synchronize with the clock signal to accurately transmit or receive data signals.

In the embodiment of the present invention, a probability that design data for the semiconductor integrated circuit passes the timing verification in step S34 at the first trial can be significantly increased compared with the currently executed method. Besides, a probability that the process returns to the upstream step of the designing stage, such as the logic synthesis in step S26 or the floor planning in step S27, is significantly decreased. Thus, the semiconductor integrated circuit can be designed within a short time period.

In the semiconductor integrated circuit of the secondary or tertiary design data, the FF circuit having the predetermined signal propagation time contained in the primary design data is replaced by the FF circuit having shorter signal propagation time. Therefore, it is possible to guarantee an operation frequency higher by about ten to a dozen percent than the operation frequency of the verification clock signal at an equivalent level to the target specifications used in the timing verification in step S29.

In the case of a circuit with a high operation frequency, FF circuits tend to have a larger proportion to all logic circuits. According to a delay improvement effect on the critical path by the replacement to the pulse-triggered FF circuit, when following a current semiconductor manufacturing process or design rules of a semiconductor integrated circuit, an operation frequency can be higher by about ten % or higher than the operation frequency of the current semiconductor integrated circuit. Thus, it is possible to guarantee an operation frequency of 1 GHz or higher for the semiconductor integrated circuit according to the embodiment of the present invention.

Particularly, the design flow which includes the synchronous circuit replacement for replacing the FF circuit connected to the subsequent stage of the critical path to a high-speed synchronous circuit is a practical technology.

Furthermore, in a pulse-triggered FF circuit, compared with a FF circuit which is not pulse-triggered type such as a master-slave FF circuit, a hold time is long, and a delay circuit may be inserted into a path having an excessively short delay.

In a pulse-triggered FF circuit according to the embodiment of the present invention, the synchronous circuit replacement in step S32 is executed for the synchronous circuit connected to the subsequent stage of the critical path detected by the timing adjustment and a predetermined delay circuit is inserted. Thus, there are advantages that a probability of the presence of a path having an excessively short delay at a next stage of the synchronous circuit can be small, and that work for additional hold time measures decreases.

Incidentally, as in the case of the primary design data, the secondary or tertiary design data which is design data on the semiconductor integrated circuit after the timing verification in step S34, can be used for reticle design data, control data for an EB exposure tool, manufacturing process data, probe test data, shipping inspection data, and the like.

FIG. 2A is a timing chart of a master clock signal CLKms and a pulsed clock signal CLKpl fed to a pulse-triggered FF circuit which is built with a pulse generator and a FF. The master clock signal CLKms transmitted from a clock generator (not shown) has a predetermined period. The master clock signal CLKms has a duty ratio 1:1 in which a time interval of logic “1” and a time interval of logic “0” are approximately equal.

First, a master-slave FF circuit having a master FF and a slave FF, as a synchronous circuit will be explained using the master clock signal CLKms shown in FIG. 2A. In the master-slave FF circuit, no input signal is fetched while the master clock signal CLKms is in logic “0”, because an internal control gate subsequent to a clock terminal of the master FF is open (hereinafter refer to mode “OFF”), and an output terminal of the master FF holds data. Meanwhile, as for the slave FF circuit, an internal control gate subsequent to a clock terminal of the slave FF is closed (hereinafter refer to mode “ON”). However, since the master FF holds data, an output terminal of the slave FF feeds data.

At a rising edge 14a of the master clock signal CLKms for changing the master clock signal CLKms from logic “0” to logic “1”, the control gate of the master FF is changed from mode “OFF” to mode “ON” so as to fetch a signal at an input terminal of the master FF, and the signal at the input terminal of the master FF can be reflected on the output terminal of the master FF.

On the other hand, the control gate of the slave FF is changed from mode “ON” to mode “OFF”, and the data at the output terminal of the slave FF is continuously held. Incidentally, the master clock signal CLKms holds logic “o” for a period of time when the master FF fetches the data at the input terminal before the rising edge 14a, i.e., until a start of a set-up time.

Subsequently, at a falling edge 14b of the master clock signal CLKms for changing the master clock signal CLKms from logic “1” to logic “0”, the control gate of the master FF is changed from mode “ON” to mode “OFF” at the instant, and the master FF is set in a data holding state.

Meanwhile, the control gate of the slave FF is changed from mode “OFF” to mode “ON”, and the data held by the master FF can be fetched to be reflected on the output terminal of the slave FF. That is, the master-slave FF circuit changes a logic value (data) of the output terminal at the falling edge 14b of the master clock signal CLKms to prevent a data punch through phenomenon.

In a period thereafter, as shown in FIG. 2A, data can be moved from the master FF to the subsequent slave FF in synchronization with timing of a rising edge 14c and a falling edge 14d of the master clock signal CLKms.

Additionally, using a plurality of cells having the master-slave FF circuit combined with a combinatorial circuit, a logic circuit such as a synchronous counter circuit, a register circuit, a shift register circuit or a universal register circuit can be built.

Next, a pulse-triggered FF circuit for achieving a higher speed operation of a semiconductor integrated circuit will be explained. In the pulse-triggered FF circuit, as shown in FIG. 2B, a pulsed clock signal CLKpl is fed from a pulse generator 54 to control synchronous operation of a pulse-triggered FF in the pulse-triggered FF circuit connected to the subsequent stage of the critical path. Here, the pulse-triggered FF has a structure similar to the master FF or the slave FF of the master-slave FF circuit.

The pulse generator 54 can be built to fetch the master clock signal CLKms into one of input terminals of a two-input AND gate 17 through an inverter 16, and to directly fetch the master clock signal CLKms into the other input terminal.

In the pulse generator 54, an output of the AND gate 17 changes at the rising edge 14a of the master clock signal CLKms so as to transfer a logic state of the pulsed clock signal CLKpl from logic “0” to logic “1”. In response to the change of the logic state, the pulse-triggered FF circuit holds data fed from a data input terminal of the pulse-triggered FF circuit. The master clock signal CLKms is fed to the other input terminal of the AND gate 17 with a delay equivalent to a signal propagation time of the inverter 16. After the delay corresponding to timing of the falling edge 15b of the pulsed clock signal CLKpl, the output of the AND gate 17 is transferred from logic “1” to logic “0”. Thus, the pulsed clock signal CLKpl is a clock signal in which a period of logic “1” is extremely short and a period of logic “0” is long compared with the master clock signal CLKms.

Subsequently, at a rising edge 15c, the pulsed clock signal CLKpl is transferred from logic “0” to logic “1” in synchronization with the rising edge 14c of the master clock signal CLKms. With a period provided by adding the signal propagation time of the inverter 16 to that of the AND gate 17, a falling edge 15d of the pulsed clock signal CLKpl is controlled.

The pulsed clock signal CLKpl transmitted from the pulse generator 54 is fed to a clock terminal of the Pulse-triggered FF to fetch output data of a preceding stage synchronous circuit.

In the pulse-triggered FF, a set-up time is short, and a circuit operation is fast. However, a hold time of the pulse-triggered FF circuit is longer than the master-slave FF circuit. Therefore, a delay circuit is inserted into an output terminal side to prevent the data punch through phenomenon.

The pulse-triggered FF circuit described in the embodiment is built to fetch the input data at the rising edges 15a, 15c of the pulsed clock signal CLKpl, which are repeated in a predetermined period. However, a synchronous latch circuit may be used.

It is more desirable to use a set-reset (SR) FF as the pulse-triggered FF in the pulse-triggered FF circuit, which operates at the rising edges 15a, 15c of the pulsed clock signal CLKpl. The SR-FF fetches input data at a pulse clock of logic “1”, and holds previous data inside even if the pulse clock is changed to logic “0”.

Incidentally, in the logic circuit designed based on a negative logic, a similar advantage is provided even if an SR FF operated at falling edges of a pulsed clock is used.

The pulse-triggered FF circuit which includes the pulse generator 54 and the pulse-triggered FF, is simple in structure compared with the master-slave FF circuit which includes two FFs. Therefore, there is an advantage that a cell area can be reduced for the pulse-triggered FF circuit. Further, if a pulsed clock signal is fed from an external source, power consumption is also reduced. Additionally, even if the pulse generator 54 is individually placed or included in the cell, the pulse-triggered FF circuit can be built in an area approximately equal to the master-slave FF circuit and the like.

Since each FF included in the pulse-triggered FF circuit and the master-slave FF circuit has similar structure such that an array of electric connection terminals of each FF such as the input terminal, the output terminal and the clock terminal, are substantially the same. For example, even when a cell of the master-slave FF circuit is replaced by a cell of the pulse-triggered FF circuit which is built by a combination of an FF and a pulse generator, there is an advantage that it is unnecessary to correct the cell layout and routing between the cells.

However, power consumption increases compared with the master-slave FF because of a high probability of clock changes (transitions of the logic states) of the pulse generator 54. Therefore, the synchronous circuits are all set to be master-slave FF circuits in the floor planning in step S27 shown in FIG. 1, and all the paths are verified in the timing verification in step S29. Thereafter, the timing adjustment in step S30 is executed only for a circuit with a higher possibility of being involved in a critical path. Since such a two-step critical path extraction is used, it is possible to entirely decrease a duration for designing a semiconductor integrated circuit.

Moreover, the pulse-triggered FF circuit leading to an increase in power consumption only replaces the cell of the master-slave FF circuit extracted in the critical path extraction in step S31. Therefore, there is an advantage that an increase in power consumption of the semiconductor integrated circuit can be suppressed.

### FIRST EXAMPLE

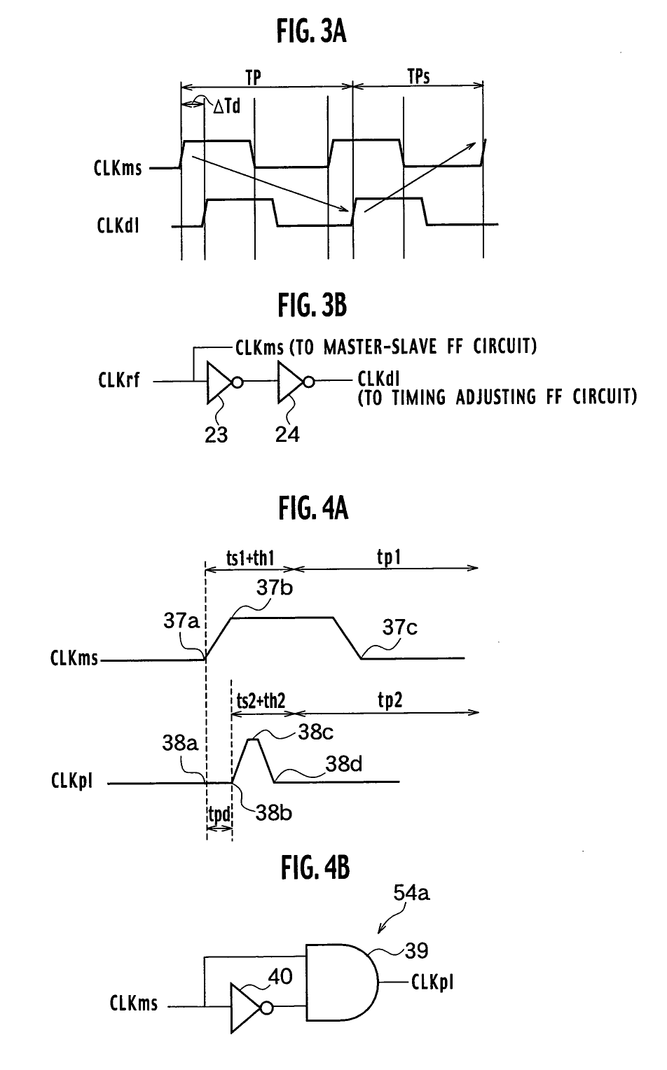

Description will be given of operation of a semiconductor integrated circuit of a first example of the embodiment of the present invention with reference to a timing chart of FIG. 3A. In a delay circuit for delaying a clock signal shown in FIG. 3B, a first inverter 23 and a second inverter 24 are two-stage cascade connected, and a master clock signal CLKms having a predetermined period is applied to an input terminal of the first inverter 23.

The master clock signal CLKms branched from the input terminal of the first inverter 23 is applied to clock terminals of basic FF circuits, such as master-slave FF circuits, as synchronous circuits contained in the primary design data created by the automated placement and routing in step S33 shown in FIG. 1. The master clock signal CLKms has a duty ratio of approximately 1:1 in which a period of logic “1” and a period of logic “0” are approximately equal.

On the other hand, a delay clock signal CLKdl is transmitted with a delayed phase with respect to the master clock signal CLKms after passing through a set of the first and second inverters 23 and 24 of the delay circuit. The delay clock signal CLKdl may be applied to clock terminals of timing adjusting FF circuits connected to a subsequent stage of the basic FF circuits to set shorter set-up time than the basic FF circuits.

For example, the delay clock signal CLKdl can be used as a synchronous signal for a second stage FF circuit subjected to the timing adjustment executed by the timing adjustment in step S30 shown in FIG. 1, more desirably, by the timing verification in step S34. A waveform of the delay clock signal CLKdl fed to a clock terminal of the second stage FF circuit is illustrated with a delay ΔTd relative to the master clock signal CLKms shown in FIG. 3A. Typically, the delay clock signal CLKdl having a phase of which is delayed relative to the master clock signal CLKms of the first stage FF circuits is applied to the second stage FF circuits, so as to adjust timing between the FF circuits.

For example, the first stage FF circuit fetches the data at the input terminal at a rising edge of the master clock signal CLKms and an output terminal of the first stage FF circuit is held at a falling edge of the master clock signal CLKms. Subsequently, a data transfer period TP until a rising edge of the delay clock signal CLKdl when the data is applied to the second stage FF circuit at a next period, can be determined. Here, the second stage FF circuit may be controlled to fetch and hold the data in response to the rising edge of the delay clock signal CLKdl.

Additionally, since a change of the delay clock signal CLKdl is delayed with respect to the master clock signal CLKms, compared with a case in which the first and second stage synchronous circuits use the master clock signals CLKms with the same phases, there is an advantage that a longer data transfer period TP can be achieved. With such a configuration, at another path branched from the critical path present between the first and second stage FF circuits, it is possible to prevent a data punch through phenomenon which occurs due to timing adjustment.

However, if a subsequent synchronous circuit which fetches data in synchronization with the master clock signal CLKms is connected to a subsequent stage of the second stage synchronous circuit, the timing of a subsequent period when the subsequent synchronous circuit fetches data comes shortly after the rising edge of the delay clock signal CLKdl in a subsequent data transfer period TPs. In such case, a master-slave FF circuit corresponding to the subsequent synchronous circuit provided in the primary design data may be replaced by a FF circuit having a shorter set-up time, such as a FF built with a low-threshold transistor, so as to adjust timing between the FF circuits. Consequently, it may be possible to suppress a data punch through phenomenon in the subsequent synchronous circuit in which the subsequent data transfer period TPs is shorter than the period of the master clock signal CLKms.

### SECOND EXAMPLE

Description will be given of operation of a semiconductor integrated circuit of a second example of the present invention with reference to a timing chart of FIG. 4A. A clock generator 54a shown in FIG. 4B is a sequential circuit having a two-input AND gate 39 and an inverter 40. A clock signal, such as a master clock signal CLKms having a predetermined period shown in FIG. 4A, is fed to one of input terminals of the AND gate 39 through the inverter 40. Additionally, the master clock signal CLKms branched from an input side of the inverter 40, is directly fed to the other input terminal of the AND gate 39.

As shown in FIG. 4A, by receiving logic “0” of the master clock signal CLKms and logic “1” from the inverter 40, the AND gate 39 feeds a pulsed clock signal CLKpl with logic “0” shown in FIG. 4A.

Next, from a time point between a rising edge 37a of the master clock signal CLKms and a reaching time 37b at logic “1”, logic “1” is transmitted to both the input terminals of the AND gate 39 until an output of the inverter 40 is changed from logic “1” to logic “0,” due to a signal propagation time of the inverter 40. Thus, logic “1” at both the input terminals of the AND gate 39 is maintained only for the signal propagation time of the inverter 40.

The pulsed clock signal CLKpl is maintained at logic “0” for a period from a time point 38a corresponding to the rising edge 37a of the master clock signal CLKms to a rising edge 38b of the pulsed clock signal CLKpl due to a signal propagation time tpd of the AND gate 39. Subsequently, the pulsed clock signal CLKpl is changed after the rising edge 38b to logic “1” only for a short time period 38c corresponding to the signal propagation time of the inverter 40. After an elapse time corresponding to the signal propagation time of the inverter 40, the output of the AND gate 39 is changed from logic “1” to logic “0” at a time point 38d.

In the second example of the embodiment, for example, the master clock signal CLKms is fed to a clock terminal of a master-slave FF circuit as a first stage FF circuit, and the pulsed clock signal CLKpl is fed to a clock terminal of a pulse-triggered FF circuit as a second stage FF circuit.

A predetermined period after the rising edge 37a of the master clock signal CLKms is used for a set-up time ts1 and a hold time th1 for the master-slave FF circuit. A predetermined period after the set-up time ts1 and the hold time th1, is used for a signal propagation time tp1 for a logic circuit connected to a output terminal of the master-slave FF circuit.

The master-slave FF circuit changes or specifies an output at a falling time point 37c of the master clock signal CLKms so as to transfer a data signal to the subsequent logic circuit.

Similarly, a predetermined period of the pulsed clock signal CLKpl after the rising time 38b is used for a set-up time ts2 and a hold time th2 for the pulse-triggered FF circuit. A predetermined period after the set-up time ts2 and the hold time th2 is used for data sending to a master-slave FF circuit placed at a next stage or used for a signal propagation time tp2 for the subsequent logic circuit.

In the second example of the embodiment, compared with a case in which the clock timing of the second stage FF circuit is simply shifted, a delay of the second stage FF circuit is decreased by an extended time of the period time at the preceding stage to compensate for timing. Thus, no limitation is imposed on the period time of the master-slave FF circuit positioned at the subsequent stage to the second stage FF circuit.

Additionally, since the inverter 40 and the AND gate 39 of the clock generator 54a are served as a clock timing delay means, it is possible to extend the period time of the first stage FF circuit by fixed time without inserting any additional element such as a delay circuit.

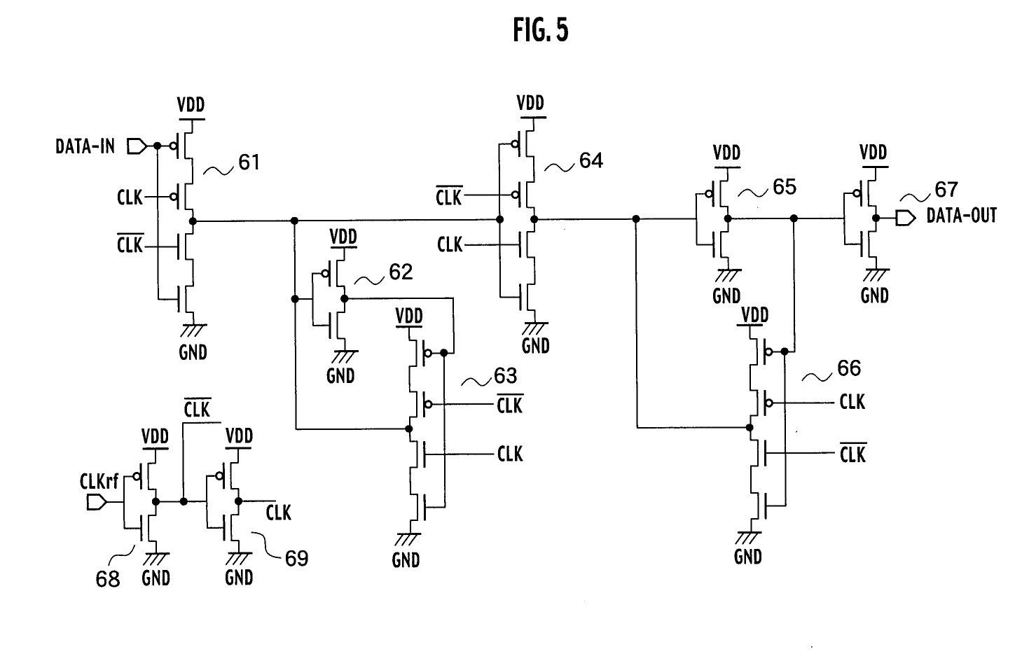

As shown in FIG. 5, a master-slave FF circuit as a synchronous circuit, and a buffer circuit may be built by, for example, combining switching elements of a plurality of CMOS transistors.

In addition to the CMOS transistors, many kinds of transistors such as pMOS transistors, nMOS transistors, bipolar transistors, and BiCMOS transistors may be used. Hereinafter, description will be given by using a CMOS circuit.

In the buffer circuit shown in the lower left in FIG. 5, pMOS transistors and nMOS transistors build CMOS inverters 68 and 69. A reference clock signal CLKrf such as a master clock signal or a delay clock signal, is applied to a gate of each transistor of the inverter 68 to change a logical state in a predetermined period.

A line is extracted from a middle node to which a source of the PMOS transistor and a drain of the nMOS transistor are connected in common. The line is connected to a gate of each transistor in the subsequent stage inverter 69, and another line is branched from the line to transmit a complementary signal CLK. An output line is extracted from a middle node to which a source of the pMOS transistor and a drain of the nMOS transistor in the subsequent stage inverter 69 to transmit a clock signal CLK.

In a switching element 61 on the left side of the drawing, two pMOS transistors and two nMOS transistors are cascade connected at a middle node, arranged between a power supply potential VDD and a reference potential GND in order from the VDD side to the GND side. Data as “DATA-IN” is applied to gates of a pair of one of the pMOS transistors and one of the nMOS transistors, the clock signal CLK is applied to a gate of the other pMOS transistor, and a complementary signal \overline{CLK} of the clock signal CLK is applied to a gate of the other nMOS transistor.

A switching element 64 is connected to the middle node of the switching element 61 and, between the power supply potential VDD and the reference potential GND, two pMOS transistors and two nMOS transistors are cascade connected at a middle node, arranged in order from the VDD side to the GND side.

Additionally, a potential of the middle node of the switching element 61 is applied to gates of a pair of one of the pMOS transistors and one of the nMOS transistors of the switching element 64, the complementary signal \overline{CLK} is applied to a gate of the other pMOS transistor, and the clock signal CLK is applied to a gate of the other nMOS transistor.

A master FF is built by an inverter 62 and a switching element 63. The master FF is connected to the middle node of the switching element 61. The inverter 62 holds a logic state of the middle node of the switching element 61.

In the switching element 63, between the power supply potential VDD and the reference potential GND, two pMOS transistors and two nMOS transistors are cascade connected at a middle node, arranged in order from the VDD side to the GND side.

An output potential of the inverter 62 is applied to gates of a pair of one of the pMOS transistors and one of the nMOS transistors, the complementary signal \overline{CLK} is applied to a gate of the other pMOS transistor, and the clock signal CLK is applied to a gate of the other nMOS transistor.

A slave FF is built by an inverter 65 and a switching element 66. The slave FF is connected to the middle node of the switching element 64. The inverter 65 holds a logic value of the middle node of the switching element 64.

In the switching element 66, between the power supply potential VDD and the reference potential GND, two pMOS transistors and two nMOS transistors are cascade connected at a middle node, arranged in order from the VDD side to the GND side.

An output potential of the inverter 65 is applied to gates of a pair of one of the pMOS transistors and one of the nMOS transistors of the switching element 66. The clock signal CLK is applied to a gate of the other pMOS transistor of the switching element 66, and the complementary signal \overline{CLK} is applied to a gate of the other nMOS transistor of the switching element 66.

An output line of the inverter 65 is connected to an inverter 67 as an output buffer circuit at a next stage. The inverter 67 is configured to transmit a complementary signal of the logic state held in the slave FF.

The master-slave FF circuit can be built totally by twenty six transistor elements including the buffer circuits. In response to a rising edge of the clock signal CLK, the switching element 61 is set to mode “ON”, to serve data fetching and data holding states of the master FF.

Additionally, in response to a falling edge of the clock signal CLK, the switching element 61 is changed to mode “OFF”, and the switching element 64 is changed to mode “ON”. Thus, while serving data fetching and data holding of the slave FF to function, a complimentary signal of a logic state of the middle node of the switching element 66 as “DATA-OUT” may be transmitted through the inverter 67.

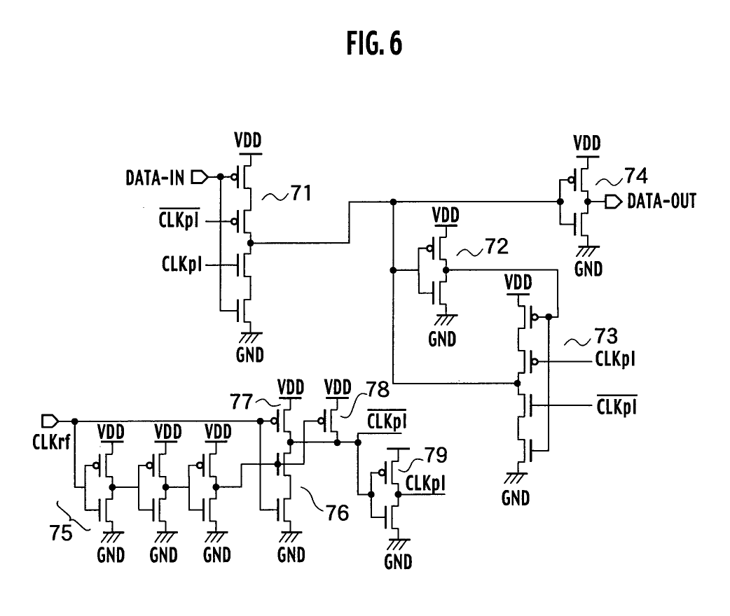

As shown in FIG. 6, a pulse-triggered FF circuit as a synchronous circuit and a pulse generator may be built by combining CMOS switching elements similarly to the master-slave FF circuit shown in FIG. 5.

The pulse generator shown in the lower left of FIG. 6 includes a delay circuit 75, a switching element 76, a pMOS transistor 78, and an inverter 79. The delay circuit 75 has inverters which are three-stage cascade connected. The switching element 76 includes a pMOS transistor 77 and two nMOS transistors. The pMOS transistor 78 has a drain and a source connected to an output of the switching element 76 and a power supply potential VDD. The inverter 79 receives an output signal of the switching element 76 and transmits a pulsed clock signal CLKpl.

In the pulse generator, the delay circuit 75 transmits logic “1” at a stage of receiving an input of the reference clock signal CLKrf of logic “0”. The transmitted logic “1” is applied to a gate of the nMOS transistor positioned at a middle stage of the switching element 76 to set mode “ON”. The transmitted logic “1” is applied to a gate of the pMOS transistor 78 connected in common to the gate of the nMOS transistor to maintain mode “OFF”.

Since the reference clock signal CLKrf of logic “0” is applied to a gate of the pMOS transistor 77 of the switching element 76, the pMOS transistor 77 is in mode “ON, and the power supply potential VDD is connected to the output of the switching element 76 to transmit logic “0” that is a complementary signal \overline{CLKpl} of logic “1” of the pulse clock signal CLKpl.

Since the inverter 79 is connected to the output of the switching element 76, an output of the inverter 79 can be maintained at logic “0”.

Subsequently, at the instant when the reference clock signal CLKrf is changed from logic “0” to logic “1”, the reference clock signal CLKrf of logic “1” is applied to the gate of the pMOS transistor 77 of the switching element 76, and the pMOS transistor 77 is changed to mode “OFF”.

Next, the reference clock signal CLKrf of logic “1” is applied to the gate of the nMOS transistor arranged on the reference potential GND side of the switching element 76. Accordingly, with the change in the output of the switching element 76 from the power supply potential VDD to the reference potential GND, the output of the inverter 79 connected to the output of the switching element 76 can be changed from logic “0” to logic “1”.

Further, with an elapse of predetermined time, the reference clock signal CLKrf applied to the delay circuit 75 is transmitted after signal propagation time of the inverters three-stage cascade connected in the delay circuit 75. A logic state of the delayed output signal is logic “0”, which changes the nMOS transistor positioned at the middle stage of the switching element 76 to mode “OFF”, and changes the pMOS transistor 78 from mode “OFF” to mode “ON”.

At the point in time, in the pulse generator, the power supply potential VDD as logic “1”, which is a complementary signal \overline{CLKpl} of logic “0” of the pulsed clock signal CLKpl, can be transmitted through the pMOS transistor 78, and the pulsed clock signal CLKpl of logic “0” can be transmitted through the inverter 79.

The pulse-triggered FF circuit shown in FIG. 6 includes a switching element 71, a latch, and an output inverter 74. The switching element 71 has two pMOS transistors and two nMOS transistors. The latch includes an inverter 72 and a switching element 73 which has two pMOS transistors and two nMOS transistors.

In the switching element 71 shown on the left side in FIG. 6, between the power supply potential VDD and the reference potential GND, the two pMOS transistors and the two nMOS transistors are cascade connected at a middle node, arranged in order from the VDD side to the GND side. Data as “DATA-IN” is applied to gates of a pair of one of the pMOS transistors and one of the nMOS transistors, a complementary signal \overline{CLKpl} is applied to a gate of the other pMOS transistor, and the pulsed clock signal CLKpl is applied to a gate of the other nMOS transistor.

The latch is built by the inverter 72 and the switching element 73. The latch is connected to a middle node of the switching element 71 to hold a logic state of the middle node of the switching element 71. In the switching element 73, between the power supply potential VDD and the reference potential GND, the two pMOS transistors and the two nMOS transistors are cascade connected at a middle node, arranged in order from the VDD side to the GND side.

An output potential of the inverter 72 is applied to gates of a pair of one of the pMOS transistors and one of the nMOS transistors of the switching element 73, the pulsed clock signal CLKpl is applied to a gate of the other pMOS transistor of the switching element 73, and the complementary signal \overline{CLKpl} is applied to a gate of the other nMOS transistor of the switching element 73.

An input of the inverter 72 is connected to the middle node of the switching element 71. A complementary signal of data which has reached the input of the inverter 72 is applied, and a logic state of the complementary signal of the data is reversed by the inverter 72. Then the signal is fed to the switching element 73.

The middle node of the switching element 73 is connected to the input of the inverter 72, and the complementary signal of the data which has reached the input of the inverter 72 can be held by the combination of the inverter 72 and the switching element 73.

Incidentally, the pulse-triggered FF inputs the held complementary signal to the output inverter 74 to reverse the logic value. Accordingly, it can be understood that a logic value of an output data (“DATA-OUT”) signal of the output of the output inverter 74 is the same as the fetched input data “DATA-IN”.

The pulse-triggered FF circuit may be built by totally twenty four transistor elements including the pulse generator. In response to a rising edge of the clock signal, the switching element 71 is set to mode “ON”, to serve data fetching and data holding states of the latch. Thus, the pulse-triggered FF circuit can serve as a FF circuit having a short set-up time, in other words, a short signal propagation time.

### THIRD EXAMPLE

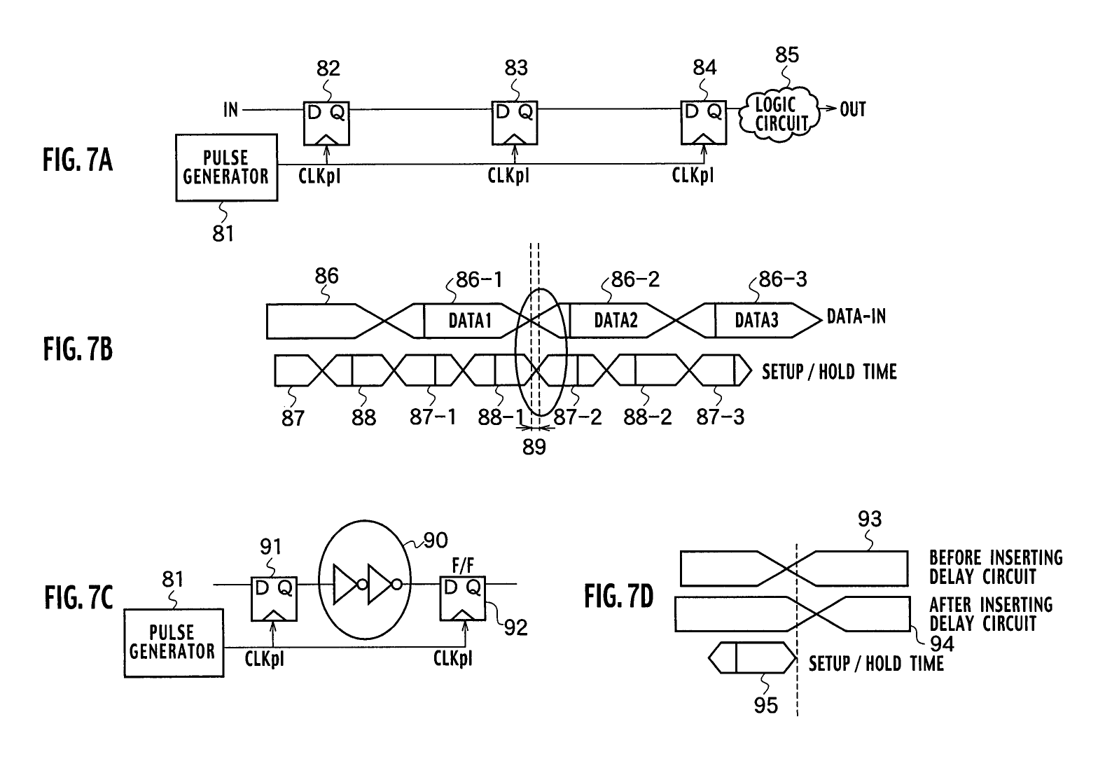

As shown in FIG. 7A, a semiconductor integrated circuit of a third example of the embodiment of the present invention, includes pulse-triggered FFs 82, 83 and 84. The FF 82 fetches data “IN” from a data input “D”. The FF 83 fetches output data from a data output “Q” of the FF 82. The FF 84 fetches output data from a data output “Q” of the FF 83.

The semiconductor integrated circuit further includes a random logic circuit 85 built by a sequential circuit which receives output data from a data output “Q” of the FF 84, and provides output data “OUT” after a predetermined signal propagation time. Additionally, an output of a clock generator 81 may be connected in common to respective clock terminals of the FFs 82 to 84. Furthermore, in synchronization with a pulsed clock signal CLK having a period of logic “1” shorter than a period of logic “0”, which is fed from the clock generator 81, the data fetched in the FF 82 may be transferred at every period of the clock signal CLK to the FF circuits 83, 84 in order. No logic circuit having signal propagation time as of a random logic circuit is placed between the FFs 82 to 84 shown in FIG. 7A.

Accordingly, if a master-slave FF circuit is used, a restriction that input data must be settled within hold time of data cannot be satisfied, and data for a next period may reach an input terminal within the hold time.

However, according to the third example of the embodiment, since the FFs 82 to 84 having short set-up time are applied to the semiconductor integrated circuit, there is an advantage that hold measures become unnecessary.

As shown in FIG. 7B, the FF 83 is operated in a period of a plurality of alternately continued periods, such as a data transit period 87, a data settlement period 88, a data transit period 87-1, a data settlement period 88-1, a data transit period 87-2, a data settlement period 88-2, and a data transit period 87-3, so as to transfer data 86, 86-1, 86-2 and 86-3 in synchronization with the FF 82 and the FF 84.

In response to a rising edge of a pulse clock fed from the pulse generator 81 at the period of the data settlement period 88-1, the FF 83 changes to a set-up time to fetch data, and then to a hold time to hold the data. Thus, the FF 83 prepares data for a synchronous circuit or a logic circuit provided in a subsequent stage.

For a synchronization timing, a signal propagation time 89 is set such that first data 86-1 which appears at the data input, is fetched in the period of the data settlement period 88-1, before second data 86-2 of a next period appears.

However, in a critical path, mismatching may occur in which the output data from the data output “Q” of the FF 82 is changed during the data settlement period 88-1, and the second data 86-2 reaches the data input “D” of the FF 83 to be fetched in the FF 83.

Incidentally, if the output data from the data output “Q” of the FF 82 is changed during the subsequent data settlement period 88-2, mismatching occurs in which third data 86-3 of a next period is fetched in the FF 83.

According to the third example of the embodiment, as shown in FIG. 7C, a delay circuit 90 in which inverters are in two-stage cascade connected is inserted between FFs 91 and 92 triggered by the pulsed clock signal CLK, thus preventing such data mismatching.

Additionally, a timing chart of FIG. 7D shows a reaching state of data which appears at a data input terminal of the pulse-triggered FF 92 with or without insertion of the delay circuit 90. During a data settlement period 95, data may pass through a critical path. Consequently, data mismatching in which data 93 of a next period is mistakenly fetched in the FF 92 without the delay circuit 90 at a last stage of a set-up/hold time of the data settlement period 95, may occur. On the other hand, by inserting the delay circuit 90, no mismatching to fetch data 94 occurs because data 94 reaches after the data settlement period 95.

However, if a plurality of delay circuits are inserted, cell power consumption and a cell area may be increased. Therefore, predetermined regulations for using delay circuits must be set in the entire semiconductor integrated circuit.

In the third example of the embodiment, insertion of a delay circuit 90 is not studied for all the paths between the cells, but after all the paths are verified in the timing verification shown in FIG. 1, determination is made by the timing adjustment as to whether or not a high-speed operation can be guaranteed for a critical path in the paths verified during timing adjustment. Subsequently, a delay circuit is inserted only into a critical path in which data mismatching might occur. Thus, it is possible to adjust a total number of delay circuits which accounts for a portion of the entire semiconductor integrated circuit.

Therefore, it is possible to easily solve the problem of considerable increases in cell area and in cell power consumption. Operation time of the computer system, which is a design source of the semiconductor integrated circuit, can be saved. Additionally, processes efficiently moves to a next designing step. Thus, a designing period of the semiconductor integrated circuit can be reduced.

### FOURTH EXAMPLE

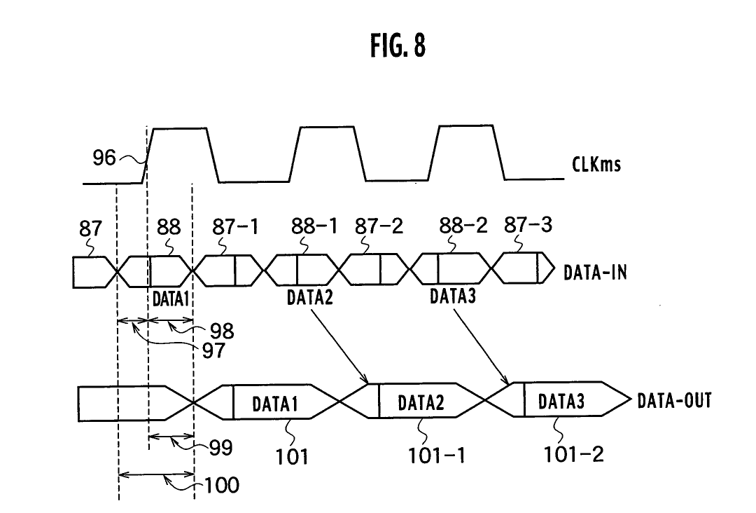

In a timing chart of a semiconductor integrated circuit of a fourth example of the embodiment of the present invention, as shown in FIG. 8, a master clock signal CLKms has a duty ratio 1:1, changing a logic state in a predetermined period. Input data DATA-IN includes periods of, for example, a data transit period 87, a data settlement period 88, a data transit period 87-1, a data settlement period 88-1, a data transit period 87-2, a data settlement period 88-2, and a data transit period 87-3. Additionally, output data DATA-OUT includes, for example, output data 101, output data 101-1, and output data 101-2 at respective periods, which are transmitted from the data output “Q” of the pulse-triggered FF 83 shown in FIGS. 7A to 7C.

The pulse-triggered FF fetches data which have reached to the data input to hold the data inside the FF in response to a rising edge of the master clock signal CLKms. Compared with the master-slave FF circuit which is standardized based on the primary design data and subjected to automated placement and routing, the pulse-triggered FF has a short signal propagation time, a fast set-up time, and a long hold time. Therefore, the pulse-triggered FF may effectively serve to prevent data mixing-up between a first stage FF circuit and a second stage FF circuit in a critical path. Incidentally, in the fourth example of the embodiment, a set-up time is assumed to be a time period for preparing data to feed to a data input with respect to the rising edge of the master clock signal CLKms.

For the pulse-triggered FF, a set-up time 97 in which data reaches the data input before the rising edge of the master clock signal CLKms which defines a start of the data settlement period 88, is stored in a computer database. Additionally, a hold time 98 during which data fetched in after the rising edge of the master clock signal CLKms is held, is stored in the computer database. Furthermore, a data delay time 99 from the rising edge of the master clock signal CLKms to a timing for settlement of data at the data output of the FF, and an FF delay time 100 provided by adding the set-up time 97 to the data delay time 99 are stored in the computer database. Thus, high-speed operation specifications of the circuit are determined.

More specifically, a critical path is verified based on a spare time of the FF delay time 100 of the first stage FF circuit and a spare time of the set-up time of the second stage FF circuit. Data mismatching of the critical path is extracted by the timing adjustment, and fine-tuning of design data may be executed to insert a delay circuit only into a path in which mismatching occurs.

### FIFTH EXAMPLE

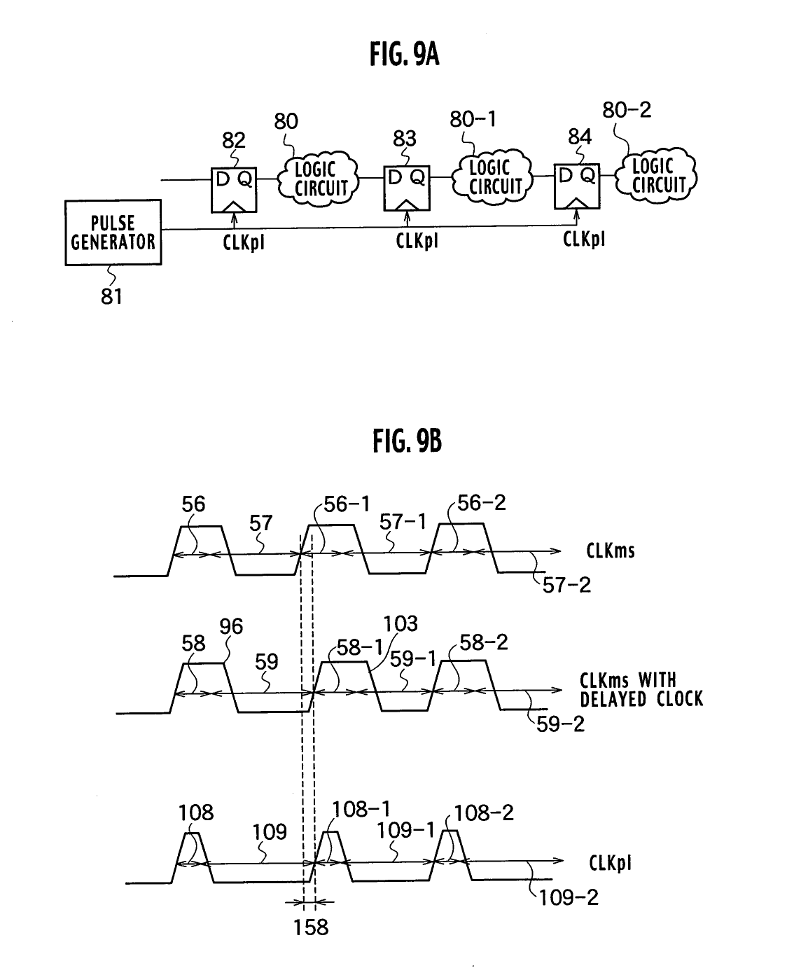

A semiconductor integrated circuit according to a fifth example of the embodiment of the present invention, as shown in FIG. 9A, includes FFs 82, 83 and 84, random logic circuit 80, 80-1 and 80-2. The FF 82 fetches data from a data input “D”, and the FF 83 fetches output data from a data output “Q” of the FF 82 through the logic circuit 80. The FF 84 fetches output data from a data output “Q” of the FF 83 through the logic circuit 80-1. The random logic circuit 80-2 includes a sequential circuit that receives output data from data output “Q” of the FF 84 after predetermined signal propagation time.

An output of a pulse generator 81 is connected in common to respective clock terminals of the FFs 82 to 84, and data fetched in the FF 82 is transferred to the FF 83, and the FF 84 in order.

In a waveform of a master clock signal CLKms, as shown in FIG. 9B, a relation is illustrated between delay times 56, 56-1 and 56-2 of the FFs 82 to 84 and logic delay permissible times 57, 57-1 and 57-2 for the use of the logic circuits 80, 80-1 and 80-2. The FF 82 transmits input data to the data output “Q” with a delay of the delay time 56 from a rising edge of the master clock signal CLKms. The logic circuit 80 in a subsequent stage for the FF 82 propagates the data at the data output “Q” to a data input “D” of the FF 83 within the logic delay permissible time 57.

The FF 83 transmits the input data to a data output “Q” with a delay of the delay time 56-1 from a rising edge of the master clock signal CLKms. The logic circuit 80-1 in a subsequent stage for the FF 83 propagates the data at the data output “Q” to a data input “D” of the FF 84 within the logic delay permissible time 57-1.

The FF 84 transmits input data to a data output “Q” with a delay of the delay time 56-2 from a rising edge of the master clock signal CLKms. The logic circuit 80-2 in a subsequent stage for the FF 84 propagates the data at the data output of the logic circuit 80-2 to a next stage circuit within a logic delay permissible time 57-2.

If the FF 83 is replaced by a FF having a short set-up time, which is built by a low-threshold transistor, it is possible to effectively delay a rising edge of the master clock signal CLKms with a delay. More specifically, the logic delay permissible time 57 is increased, whereas the next logic delay permissible time 57-1 is decreased. In this case, if a signal propagation time of the logic circuit 80-1 is not long, it can be expected that the increment of the logic delay permissible time 57 will be effective for critical path mismatching which may occur between the FF 82 and the FF 83.

In a waveform of the delayed master clock signal CLKms, as shown in FIG. 9B, a relation of synchronous operation is illustrated, where the master clock signal CLKms and a delay clock 103 are independently supplied to the FFs 82 to 84.

The FF 82 transmits input data to the data output “Q” with a delay of a delay time 58 from a rising edge of the master clock signal CLKms. The logic circuit 80 of a subsequent stage of the FF 82 propagates the data at the data output “Q” of the FF 82 to the data input “D” of the FF 83 within the logic delay permissible time 59.

The FF 83 transmits the input data to the data output “Q” with a delay of a delay time 58-1 from a rising edge of the delay clock 103 having a clock delay 158 independent of the master clock signal CLKms. The logic circuit 80-1 of a subsequent stage of the FF 83 propagates the data at the data output “Q” of the FF 83 to the data input “D” of the FF 84 within the logic delay permissible time 59-1.

The FF 84 transmits the input data to the data output “Q” with a delay of a delay time 58-2 from a rising edge of the master clock signal CLKms. The logic circuit 80-2 of a subsequent stage of the FF 83 propagates the data at the data output “Q” of the FF 83 to a circuit of a next stage within the logic delay permissible time 59-2.

With such configuration, the delay clock 103 is shifted from the rising edge of the master clock signal CLKms with the clock delay 158. In other words, the logic delay permissible time 59 is increased, while the next logic delay permissible time 59-1 is decreased.

If a signal propagation time of the logic circuit 80-1 is not considerably long compared with the clock delay 158, it can be expected that the increment of the logic delay permissible time 59 will be effective for critical path mismatching which occurs between the FF 82 and the FF 83.

In a waveform of a pulsed clock signal CLKpl shown in FIG. 9B, a relation of synchronous operation is illustrated for the FFs 82 to 84 triggered by a pulsed clock. The FF 82 transmits input data to the data output “Q” with a delay of a delay time 108 from a rising edge of the pulsed clock signal CLKpl. The logic circuit 80 of the subsequent stage of the FF 82 propagates the data at the data output “Q” of the FF 82 to the data input “D” of the FF 83 within a logic delay permissible time 109.

The FF 83 transmits input data to the data output “Q” with a delay of a delay time 108-1 from a rising edge of the pulsed clock signal CLKpl. The logic circuit 80-1 of the subsequent stage of the FF 83 propagates the data at the data output “Q” of the FF 83 to the data input “D” of the FF 84 within a logic delay permissible time 109-1.

The FF 84 transmits input data to the data output “Q” with a delay of a delay time 108-2 from a rising edge of the pulsed clock signal CLKpl. The logic circuit 80-2 of the subsequent stage of the FF 84 propagates the data at the data output “Q” of the FF 84 to the data input of the next stage within a logic delay permissible time 109-2.

With such configuration, the pulse-triggered FF 82 to 84 may have a fast set-up time, a short signal propagation time, and a short delay time. Accordingly, the logic delay permissible time 109, 109-1, 109-2 of the respective stages can be set long. Thus, a margin of a critical path can be increased to reduce a possibility of data mismatching.

### SIXTH EXAMPLE

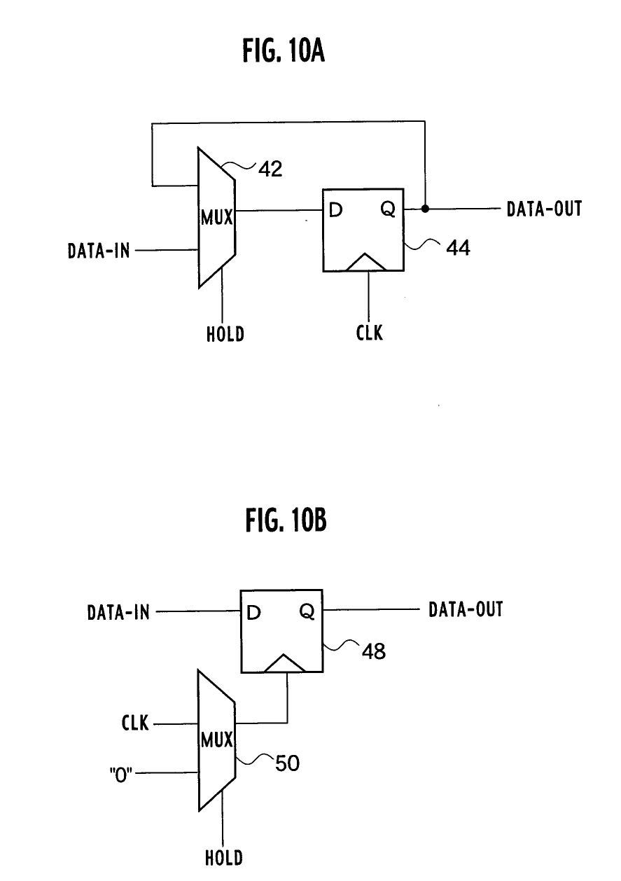

FIG. 10A is a block diagram of a FF circuit used for a sixth example of the embodiment of the present invention. An FF 44 equipped with a feedback loop, is built in such a manner that an output of a multiplexer 42 is connected to a data input “D” of the FF 44, and the feedback loop is branched from a data output “Q” transmitting an output data DATA-OUT to be connected to one input of the multiplexer 42. Additionally, the FF 44 is configured such that input data DATA-IN is fed to the other input of the multiplexer 42. Control can be executed to select one of the output data DATA-OUT and the input data DATA-IN transferred through the feedback loop depending on a logic state of a hold signal fed to the multiplexer 42.

As shown in FIG. 10B, an pulse-triggered FF 48 is configured such that input data DATA-IN is fed to a data input “D”, and a data output “Q” is connected to a circuit of a next stage to transmit output data DATA-OUT controlled by a multiplexer 50. A clock input of the FF 48 is connected to an output of the multiplexer 50.

In the multiplexer 50, a pulse clock signal CLK is fed to one input, and logic “Q” is fed to the other input. Control can be executed to select one of the pulse clock signal and logic “0” depending on a logic state of a hold signal HOLD applied to the multiplexer 50.

In the sixth example of the embodiment, timing verification is executed for all paths by temporarily designing a semiconductor integrated circuit which includes the FF 44 equipped with the feedback loop, based on the primary design data. Subsequently, timing adjustment is executed to extract a path in which a time lag occurs in a clock timing, and replacement is executed to replace the multiplexer 42 and the FF 44 equipped with the feedback loop by the multiplexer 50 and the pulse-triggered FF 48. Then, a circuit layout and a route pattern are fine-tuned by automated placement and routing.

With such configuration, it is possible to prevent an increase in a delay time of the signal propagation time caused by the multiplexer 42 inserted into a data path of the FF 44 equipped with the self feedback loop. Further, by the multiplexer 50 connected to a clock terminal of the pulse-triggered FF 48, an increase in a delay time of the signal propagation time of the data path can be prevented.

Additionally, from the viewpoint of suppressing clock skew, the pulse-triggered FF 48 may receive a pulse clock signal in which a period of logic “1” is short in a single period of a data input and a data output of the FF 48, or a period of logic “0” is short in the case of non logic design, to the clock terminal of the FF 48 through the multiplexer 50.

Further, there is an advantage that by controlling the operation of the pulse-triggered FF, an operation failure caused by a time lag in a clock timing can be eliminated, and data can be passed to a circuit of a next stage only within the signal propagation time of the pulse-triggered FF 48.

Compared with the FF before the replacement step, since it is unnecessary to connect a multiplexer 42 on the data input side, there are advantages that the signal propagation time can be made shorter, and that increases in cell area and in power consumption can be suppressed.

Description will be given of operations of the FF 44 equipped with the feedback loop and the pulse-triggered FF 48 with reference to FIGS. 10A and 10B. The FF 44 is operated by applying to the clock terminal a clock signal with a predetermined period of a duty ratio 1:1. When a hold signal HOLD as a control signal is in logic “1”, the multiplexer 42 can select the feedback-looped output data DATA-OUT to pass to the data input “D” of the FF 44 equipped with the feedback loop, and can repeatedly receive data of the previous period. On the other hand, if the hold signal HOLD is in logic “0”, the multiplexer 42 can select the input data DATA-IN to pass to the data input “D” of the FF 44.

In any case, desired data can reach the data input “D” of the FF 44 after an elapse of the signal propagation time of the multiplexer 42 from a point when the hold signal HOLD is changed, and the data can be transferred in synchronization with the rising edge of the clock signal CLK. However, the addition of the multiplexer 42 may not be suitable for achieving a higher speed of the entire circuit.

Furthermore, in the pulse-triggered FF 48, if the hold signal HOLD of logic “1” has been fed to the multiplexer 50, a signal of logic “0” is selected to be transmitted to the clock terminal of the pulse-triggered FF 48. In this case, the FF 48 maintains a data holding state or output signal unchanging state, in which no data is fetched in from the data input “D”.

On the other hand, if the hold signal HOLD is in logic “0”, the pulsed clock signal CLK can be selected to pass the pulsed clock signal CLK to the clock terminal of the FF 48. In response to a rising edge of the pulsed clock signal CLK, while receiving data from the data input “D” to hold it inside, the FF 48 can change the data output “Q” to pass the data to the circuit of the next stage.

### SEVENTH EXAMPLE

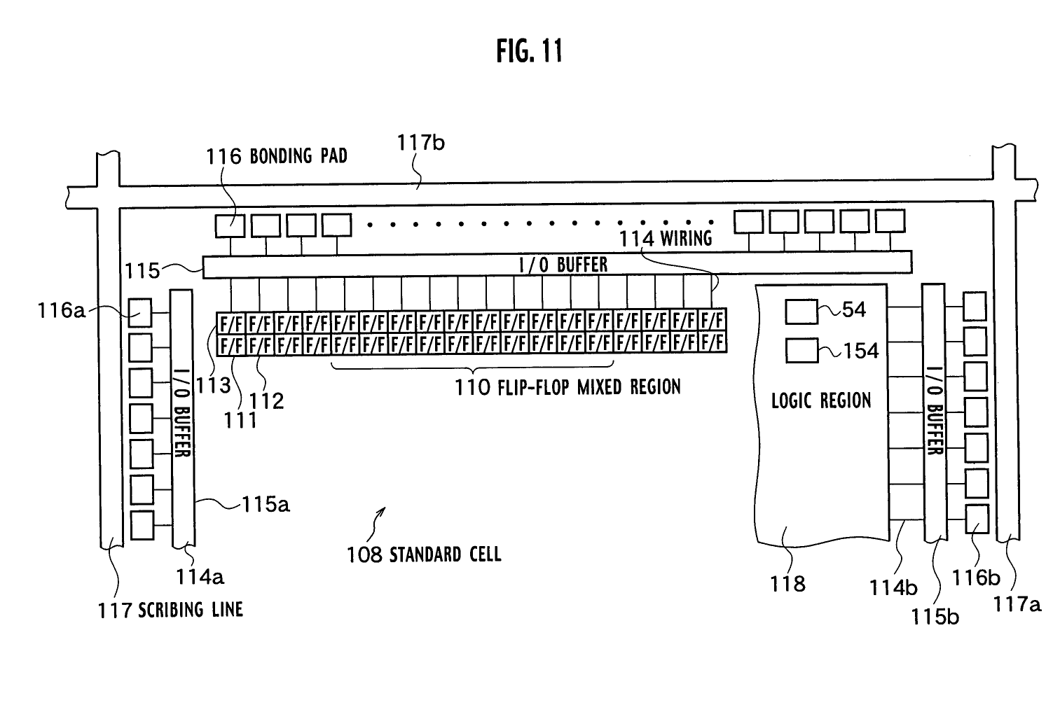

FIG. 11 is a circuit layout diagram of a semiconductor integrated circuit of a seventh example of the embodiment of the present invention. A standard cell 108 as a semiconductor integrated circuit includes a plurality of cells in a region surrounded on four sides by scribe line 117 on the left end, a scribe line 117a on the right end, a scribe line 117b on the upper end, and a scribe line on a lower end (not shown), and wirings 114, 114a and 114b for connecting the cells.

The standard cell 108 includes, for example, master-slave FF circuits 111 and 112, pulse-triggered FF circuits 113, and a FF mixed region 110 in which a pulse-triggered FF is placed in the vicinity of a master-slave FF.

Additionally, a clock generator 154 which supplies a master clock signal to the FF circuits, and a pulse generator 54 which supplies a pulsed clock signal to the pulse-triggered FF is provided in a logic region 118.

The master-slave FF circuits 111 and 112 are placed as synchronous circuits contained in the primary design data used for the automated placement and routing step shown in FIG. 1.

On the other hand, the pulse-triggered FF circuits 113, and the pulse-triggered FF included in the FF mixed region 110 are placed based on the secondary design data.

The master-slave FF, and the pulse-triggered FF may be built by cells with substantially the same areas. Accordingly, a pulse-triggered FF can replace a master-slave FF in the FF mixed region 110 without changing a cell area. Therefore, it is possible to executed efficient designing of a standard cell without any significant change in a cell layout.

More specifically, compared with a FF of non pulse-triggered type, such as a master-slave type, a structure of the pulse-triggered FF circuit is simple. Therefore, it is possible to reduce a cell area.

Additionally, in the method for designing a semiconductor integrated circuit according to the seventh example of the embodiment, since the numbers of transistor elements placed in the cells can be at approximately equal level, there is an advantage that any significant change is not required in a circuit design even if the FF mixed region 110 is placed.

Furthermore, in the standard cell 108, bonding pads 116, 116a and 116b are placed in the vicinity of the scribe lines 117, 117a, 117b, to provide electric connection with an outside circuit or a wafer probe test. The FF placed in the FF mixed region 110 and the FF circuits 111, 112, 113 are connected to the bonding pads 116 through wirings 114 and an I/O buffer circuit 115. A random logic circuit (not shown) including a sequential circuit, and the clock generator, which are placed in the logic region 118, are connected to the bonding pads 116b through wirings 114b and an I/O buffer 115b. Another random logic circuit and another synchronous circuit (not shown) are also connected to the bonding pads 116a through wirings 14a and an I/O buffer 115a.

The operations and effects described in the embodiment of the present invention are only recited as the most desirable operations and effects of the invention. The operations and effects of the invention are not limited to those described in the embodiment of the present invention.

1. A computer implemented method for designing a semiconductor integrated circuit, comprising:
placing a first cell including a first stage synchronous circuit having a signal propagation time, a second cell including a second stage synchronous circuit having a signal propagation time almost equal to the first stage synchronous circuit, and a third cell including a logic circuit to be placed between the first stage synchronous circuit and the second stage synchronous circuit;
routing wirings so as to electrically connect the first through third cells;
verifying a signal propagation timing of the semiconductor integrated circuit having the first to third cells;
adjusting the signal propagation timing based on a critical path of the signal propagation timing of the semiconductor integrated circuit; and
extracting the critical path placed between the first and second synchronous circuit to replace the second stage synchronous circuit by a synchronous circuit of a different synchronous type from the first stage synchronous circuit so as to provide a shorter signal propagation time than the first stage synchronous circuit.

2. The method of claim 1, wherein, if the first stage synchronous circuit is a master-slave synchronous circuit, the second stage synchronous circuit is replaced by a pulse-triggered synchronous circuit.

3. The method of claim 1, wherein the second stage synchronous circuit is placed in a vicinity of the first stage synchronous circuit.

4. The method of claim 1, wherein the semiconductor integrated circuit is built by a standard cell including cells of a master-slave flip-flop circuit and a pulse-triggered flip-flop circuit, the cells having substantially the same area and substantially the same positions of electric connection terminals.

5. The method of claim 1, wherein the second stage synchronous circuit is subjected to automated placement and routing with the first stage synchronous circuit having substantially the same area.

6. The method of claim 1, wherein the logic circuit is a delay circuit inserted between the first and second stage synchronous circuits.

7. The method of claim 1, wherein the first and second stage synchronous circuits are connected to a pulse generator to adjust the signal propagation timing.

8. A semiconductor integrated circuit, comprising:
a flip-flop mixed region including a master-slave flip-flop and a pulse-triggered flip-flop, the master-slave flip-flop and the pulse-triggered flip-flop having substantially the same area, the pulse-triggered flip-flop being placed in a vicinity of the master-slave flip-flop; and
a clock generator configured to supply a clock signal to the master-slave flip-flop.

9. The semiconductor integrated circuit of claim 8, wherein the pulse-triggered flip-flop is connected to a subsequent stage of the master-slave flip-flop.

10. The semiconductor integrated circuit of claim 8, wherein the master-slave flip-flop and the pulse-triggered flip-flop are connected through a delay circuit.

11. The semiconductor integrated circuit of claim 8, wherein the clock generator is connected to a pulse generator of the pulse-triggered flip-flop to supply a pulsed clock signal.
